(19) United States
(12) Patent Application Publication
(10) Pub. No.: US 2012/0228462 A1
(43) Pub. Date: Sep. 13, 2012

(54) ANTI-THEFT DEVICE FOR SYSTEM ABLE TO BE ATTACHED TO A WALL

(75) Inventor: Dominik RIESEN, Luzern (CH)

(73) Assignee: Siemens Aktiengesellschaft, Munich (DE)

(21) Appl. No.: 13/414,398

(22) Filed: Mar. 7, 2012

(30) Foreign Application Priority Data
Mar. 7, 2011 (EP) EP11157210

(51) Int. Cl. E05B 73/00; B23P 11/00; F16M 13/02

(52) U.S. Cl. 248/551; 29/428

(57) ABSTRACT

A front module is affixed to a carrier module able to be attached to a wall. The device features an anti-theft facility embodied such that the front module and the carrier module are able to be fixed to one another by the device, and that the anti-theft facility is able to be released from the front module and/or the carrier module exclusively by a special tool.

### CROSS REFERENCE TO RELATED APPLICATIONS

This application is based on and hereby claims priority to European Application No. 11157210 filed on Mar. 7, 2011, the contents of which are hereby incorporated by reference.

### BACKGROUND

Described below is a device for anti-theft fixing of a front module to a carrier module able to be attached to a wall. Also described are an arrangement and a system for attachment to a wall, and a method for anti-theft fixing of a front module to a carrier module able to be attached to a wall.

Function systems, such as sockets, light switches or thermostats for example, are attached directly to walls of a building. In such cases the systems generally consist of a front module and a carrier module. The carrier module is usually attached to the wall. The front module can for example be attached by a retaining spring to a mounting plate of the carrier module. As a result of the retaining springs the front module can be installed without additional tools. It is also possible to remove the front module without using a tool. Although this makes it possible to remove the front module more quickly, it often leads to unauthorized removal of the front module by users. In other words conventional front modules can be quickly removed and thereby stolen quickly and unobtrusively. Above and beyond this, removal of the front module without permission by persons not authorized to do so can lead to a system becoming unsafe and to a system outage.

### SUMMARY

Described below is a device to protect a system able to be attached to the wall against theft.

This is achieved by a device for anti-theft fixing of a front module to a carrier module able to be attached to the wall, by an arrangement, by a system for attachment to a wall and by a method for anti-theft fixing.

In accordance with a first aspect, a device for anti-theft fixing of a front module to a carrier module able to be attached to a wall is created. The device has an anti-theft facility. The anti-theft facility is embodied such that the front module and the carrier module are able to be fixed to each other by the facility and such that the anti-theft facility is able to be released from the front module and/or the carrier module exclusively by a special tool.

According to a further aspect, an arrangement is described having a front module for fitting to a carrier module able to be attached to the wall. The arrangement also features the device described above.

According to a further aspect, a system for attachment to the wall is described. The system features a carrier module and the arrangement described above.

According to a further aspect, a method for anti-theft fixing of a front module to a carrier module able to be attached to the wall is described. In accordance with the method the front module is fixed to the carrier module by the above-described device with the anti-theft facility.

The term “wall” is to be understood as a spatial delimitation of a room of a building, especially a floor, a ceiling or a side wall of a room.

The term “carrier module” refers to a module able to be attached to the wall. The carrier module can for example be able to be attached by a screw connection or by a clamp connection to the (surface of the) wall or into a cavity within the wall. The carrier module is also configured to attach the function module. The carrier module can be a metal frame or a plastic arrangement.

The front module is embodied to be attached to the carrier module, for example by a screw connection and/or by a clamp connection. The front module can for example have a specially shaped surface, in which for example standardized or predefined components, such as a male (power or data) connector (according to the DIN specification for example) are guided and supported. In other words the front module can for example embody a part of a wall socket. Furthermore a function device of the front module can be embodied with an operating element and/or a display element. The function device of the front module can for example be a thermostat or any other given input or display device for specific room technologies (e.g. control for room ventilation, heating elements etc.

The term “anti-theft facility” refers to a facility, which on the one hand is fixed to the front module and on the other hand to the carrier module, in order in this way to provide an anti-theft fixing of the front module to the carrier module. At the same time the anti-theft facility can allow a smaller relative movement between the front module and the carrier module, without however allowing the front module to be removed completely from the carrier module. The anti-theft facility is especially fixed to the front module and/or the carrier module such that exclusively a special tool can release the corresponding fixing. In other words the anti-theft facility is configured so that removing the front module from the carrier module by hand or manually without a special tool is impossible or will be prevented.

The anti-theft facility thus makes it possible to protect against the theft of the front module from the carrier module. An unauthorized user can only remove the front module from the carrier module with great effort and by using the special tool. This means that the user needs much longer to remove the front module than if it were possible simply to remove the front module from the carrier module manually or by hand. In particular the user needs a unique special tool to release the anti-theft facility, so that this alone makes stealing the front module more difficult.

The term “special tool” refers to a specially embodied unique tool with which exclusively the fixing of the anti-theft facility can be released from the front module and/or the carrier module. The special tool can be adapted to a specific embodiment of the anti-theft facility and/or to an access opening in the front module and/or the carrier module by its profile such that exclusively a corresponding special tool designed to release the anti-theft facility is able to be used. In other words the anti-theft facility cannot be released with other tools not designed for releasing the anti-theft facility.

The exclusivity, whereby only a specially-made and matched special tool can release a corresponding anti-theft facility, can be implemented for example on the basis of a specific shaping or embodiment of the anti-theft facility and/or by a specific shaping or embodiment of an access channel or insertion opening of the anti-theft facility. Typical embodiments of this are explained in greater detail below.

According to a further advantageous embodiment the anti-theft facility has a first end section and a second end section. The first end section is shaped such that a first fixing is able to be established with a first attachment area of the front module. Furthermore the second end section is shaped such that a second fixing is able to be established with a second attachment area of the carrier module. The first end section and/or the second end section are embodied such that the first fixing and/or the second fixing is exclusively able to be released by the special tool.

The anti-theft facility can for example be embodied from a linear-shape molded body (e.g. a bar or pin) or e.g. with a U-shaped cross-section or profile. On one side the front module and on the other side the carrier module can be attached to the respective ends of the anti-theft facility. In this case one of the end sections can be able to be released by the special tool or both of the end sections can be able to be released by the special tool. The first fixing and/or the second fixing cannot be released without the necessary special tool, so that an unauthorized user cannot remove the front module from the carrier module without the special tool, at least without running the risk of destroying one of the modules and devices.

According to a further advantageous embodiment the first end section features a first snap-on element. The first snap-on element is embodied such that this is able to be snapped into the first attachment area of the front module. The first snap-on element can for example represent a wedge-shaped element or a hook-shaped element. The first attachment area of the front module can for example have an opening into which opening an overhang or an undercut is formed. On insertion of the first end section into the opening the overhang presses against the snap-on element so that the element deforms elastically. When the snap-on element has fitted the overhang in the opening of the first attachment area, the snap-on element can bend back into its initial position and, with the overhang or the undercut, effect a wedging into the opening. On the basis of this wedging the snap-on element is prevented from being pulled out of the opening against the direction of insertion.

By using the special tool the snap-on element can be deformed elastically (or for a one-off use also plastically), so that the wedging of the snap-on element with the overhang within the opening of the first attachment is released and it is made possible for the user to pull out the first end section from the first attachment area again. Thus the first fixing can be released for example.

In a further exemplary embodiment the second end section can feature a second snap-on element. The second snap-on element is embodied such that the element is able to be snapped into the second attachment area of the carrier module. The second snap-on element as well as the second attachment area can be embodied in accordance with the first snap-on element described above and the first attachment area described above.

According to a further advantageous embodiment the second end section is embodied such that this section is able to be screwed into the second attachment area of the carrier module. In other words a screw connection is thus made possible between the second end section and the second attachment area. The second end section can have an outer thread for example which can be screwed into an associated hole with an inner thread of the second attachment area. As an alternative the second end section can have a hollow-cylindrical shape with an internal thread and the second attachment area can feature a rod-shaped element with an external thread, wherein the hollow cylinder of the second end section can be screwed onto the rod of the second attachment area.

A typical embodiment having for example a snap-on connection as its first fixing and a screw connection as its second fixing, as explained above, represents a robust fixing. For example the snap-on connection prevents a twisting or screwing of the anti-theft facility, so that a release of the second fixing is prevented by the snap-on connection. Thus, for example, a user must first release the first fixing or the snap-on connection between the front module and the anti-theft facility by using the special tool. Subsequently, for example after removal of the front module, the user can release the screw connection or the second fixing and remove the anti-theft facility entirely.

According to a further advantageous embodiment the second fixing can also be provided by a soldered, welded or glued connection.

According to a further advantageous embodiment of the arrangement of the front module has an access opening. The front module surrounds the anti-theft facility such that the anti-theft facility is only able to be reached by the special tool for releasing the anti-theft facility exclusively through the access opening. Likewise the access opening can be embodied such that a special tool is only able to be introduced exclusively through the access opening. An exemplary embodiment of this is explained below.

In the exemplary embodiment the front module encloses the anti-theft facility. The anti-theft facility is thus housed in the front module. The access opening in the front module is embodied such that for example a user cannot insert his fingers into the access opening and reach the anti-theft facility. For example the access opening has a largest internal dimension (e.g. diameter, width, length) which is less than 1 cm, especially less than 0.5 cm. This prevents an unauthorized user without additional special tool releasing the first fixing between the anti-theft facility and the front module. Even if the unauthorized user were to have a special tool to hand the period of time for removing the front module from the carrier module would be increased, so that this would likewise make theft of the front module more difficult.

According to a further advantageous embodiment the access opening forms a cross-sectional shape which is matched to a profile shape of the (associated) special tool such that the anti-theft facility is only able to be reached through the access opening exclusively by the special tool.

The access opening can for example have as its cross-sectional shape a circular shape, a triangular shape, an elliptical shape, a rectangular shape or even a non-symmetrical corrugated and/or angled cross-sectional shape. In other words the cross-sectional shape can have a mixture of round, straight and angular areas.

The profile shape of the special tool describes a circumferential shape of the special tool. The profile shape is matched with its circumference to the cross-sectional shape of the access opening. If for example the cross-sectional shape is a triangle, the profile form of the special tool likewise is a corresponding triangle. The profile shape is also adapted with its dimensions to the dimension of the cross-sectional shape. Thus for example exclusively a special tool with a triangular shape can be introduced into the access opening in the above example. The access opening can also have a depth, wherein the cross-sectional shape runs constantly and homogeneously in its depth. In another typical embodiment the access opening can likewise have a non-symmetrical and non-constant course along its depth. In this exemplary embodiment for example a lock and key principle can be implemented, wherein the special tool is able to be introduced as the key into the access opening as the lock. In other words the access opening thus has a defined three-dimensional (inner) surface shape, wherein the outer surface (profile shape) of the special tool is adapted to the three-dimensional course of the surface of the access opening.

Secure anti-theft protection is created with this exemplary embodiment, since penetration into the access opening and thus reaching the anti-theft facility is only made possible exclusively with the unique special tool. This makes it more difficult for an unauthorized user to forge a special tool. This also ensures that a user can only release the first fixing between the anti-theft facility and the front module exclusively by the unique special tool.

According to a further advantageous embodiment the front module has a narrow side in which the access opening is molded.

The narrow side of the front module is for example the side surface, the surface of which is smaller than the surface of an end face of the front module. The end face surface can run in a plane of which the normal is parallel to a normal of a wall plane in which the wall runs if the front module is attached to the carrier module attached in the wall. To put it another way the narrow side is that side which is embodied between the wall surface and the end face surface of the front module. The narrow side essentially runs at right angles to the end face surface of the front module.

Thus the entire end face surface of the front module can be used in order to accommodate function devices such as a control panel or a display facility. The end face surface is thus not occupied by the function of the anti-theft facility, thus the optical appearance is not disrupted by the access opening when looking at the end face surface. In addition the molding of the access surface on the narrow side leads to less contamination, and for example clogging of the access opening since the narrow side can be embodied free of control elements.

According to a further advantageous embodiment, the front module has an opening to receive the anti-theft facility. The first attachment area especially features the receptacle opening in order to establish the first fixing. The receptacle opening is embodied so that the anti-theft facility is able to be pushed into the receptacle opening in a first direction. The access opening is embodied so that the special tool is able to be inserted in a second direction into the access opening. The receptacle opening and the access opening are embodied so that the first direction differs from the second direction.

In a further exemplary embodiment the carrier module features a further receptacle opening to accommodate the anti-theft facility. The second attachment area especially features a further receptacle opening, in order to establish the second fixing. The further receptacle opening is embodied such that the anti-theft facility is able to be inserted in the first direction into the further receptacle opening. A further access opening in the carrier module is embodied such that the special tool is able to be inserted in the second direction into the further access opening. The further receptacle opening and a further access opening are embodied such that the first direction differs from the second direction.

The embodiment described above increases the anti-theft capabilities. If for example the first direction and the second direction are parallel, the screw connection as the second fixing between carrier module and anti-theft facility can be released by tools not provided, such as a pair of pliers for example, in order by this action to remove the front module along with the anti-theft facility from the carrier module. If the first direction differs from the second direction such twisting is not possible so that the anti-theft capability is enhanced.

According to a further advantageous embodiment of the system the carrier module is embodied for attachment to the wall such that a cavity in the wall is able to be covered by a carrier module.

The carrier module can for example include a flush-mounted socket. The carrier module can also have a mounting plate which can have a greater diameter than the cavity so that areas covering the wall are produced. In these areas of the mounting plate covering the wall attachments such as screws for example can be inserted through the mounting plate into the wall so that a fixing of the mounting plate and thus of the carrier module into the cavity of the wall is provided.

According to a further advantageous embodiment the front module includes a function device. The carrier module has a connecting element. The function device is able to be connected to the connecting element for signal transmission.

The function device can for example be a thermostat, a holder for a plug (socket), a display element (for example digital display of the temperature etc.), or represent other control elements for building technology.

The front module can further include a frame or a panel which surrounds the edge of the function device. The frame can hold the function device. The attachment to the carrier module can be provided by the frame. In addition the first attachment area for fixing the anti-theft facility can be embodied in the frame. As an alternative the first attachment area can also be embodied in the function device.

The connecting element typically includes electrically-conductive elements. Signal-transmitting elements (such as a line for example) can be connected to an area of the connecting element. A contact area with the function device can be embodied on another area of the connecting element, so that the signals are able to be transmitted between the signal transmission element and the function device.

According to a further advantageous embodiment the connecting element is configured such that a line which runs between the wall and the connecting element (within the cavity for example) is able to be connected to the connecting element for signal transmission. The connecting element is configured so that the function device is able to be connected to the connecting element from outside the wall. This enables the user to operate the function device from outside the wall and transmit corresponding signals to the line. In addition display signals can be transmitted from the line to the function device for operating a display facility for example.

A signal is to be understood as analog or digital signals for example. In addition the signal transmission can also describe a power supply between the function device and the line. For example the function device can thus represent a switch element or a receptacle for a power plug.

An anti-theft facility which can be attached to the carrier module and, on installation of the front module, latches into a first attachment area of the front module, is described. Both modules, the carrier module and the front module, are thus fixed. Further attachment elements between the front module and the carrier module can also be used.

If a snap-on connection is embodied between the front module and the anti-theft facility this makes it possible for special tool not to be needed when the front module is attached to the anti-theft facility. Only on removal of the front module from the anti-theft facility is the special tool needed. This means that the anti-theft facility does not delay the installation of the front module but enhances the anti-theft facility. Furthermore the customer or the user does not have to choose whether he wishes to use the anti-theft facility or not, since additional attachment elements and attachment connections can be provided between the carrier module and the front module, such as further screw connections or further snap-on connections for example. If the access opening described above is made in the narrow side of the front module for example, the appearance of the system is not influenced or changed by the additional anti-theft facility by the anti-theft facility and the access opening in the front module.

The anti-theft facility can likewise have a desired or random length, so that for example installation-dependent differences in the position between front module and carrier module of example more than 4 mm can be overcome.

It is pointed out that the embodiments described here merely represent a restricted selection of possible embodiment variants. It is thus possible to combine the features of individual embodiments in a suitable manner with each other so that, for the person skilled in the art, a plurality of different embodiments is to be seen as disclosed by the explicit embodiment variants here.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic diagram of the modules and components belonging to the system in a non-connected state in accordance with an exemplary embodiment;

FIG. 2 is a schematic diagram of the modules and components in a state in which they are attached to each other, in accordance with an exemplary embodiment;

FIG. 3 to FIG. 5 are schematic diagrams of perspective, front and side views, respectively, of an anti-theft facility in accordance with an exemplary embodiment; and

FIG. 6 is a partial section view of a system in accordance with an exemplary embodiment; and

FIG. 7 is a partial section view of the system in accordance with an exemplary embodiment, wherein the front module is hooked onto the anti-theft facility.

### DETAILED DESCRIPTION OF THE PREFERRED EMBODIMENT

Reference will now be made in detail to the preferred embodiments, examples of which are illustrated in the accompanying drawings which are schematic and not true-to-scale. The same or similar components are provided with the same reference characters in the figures.

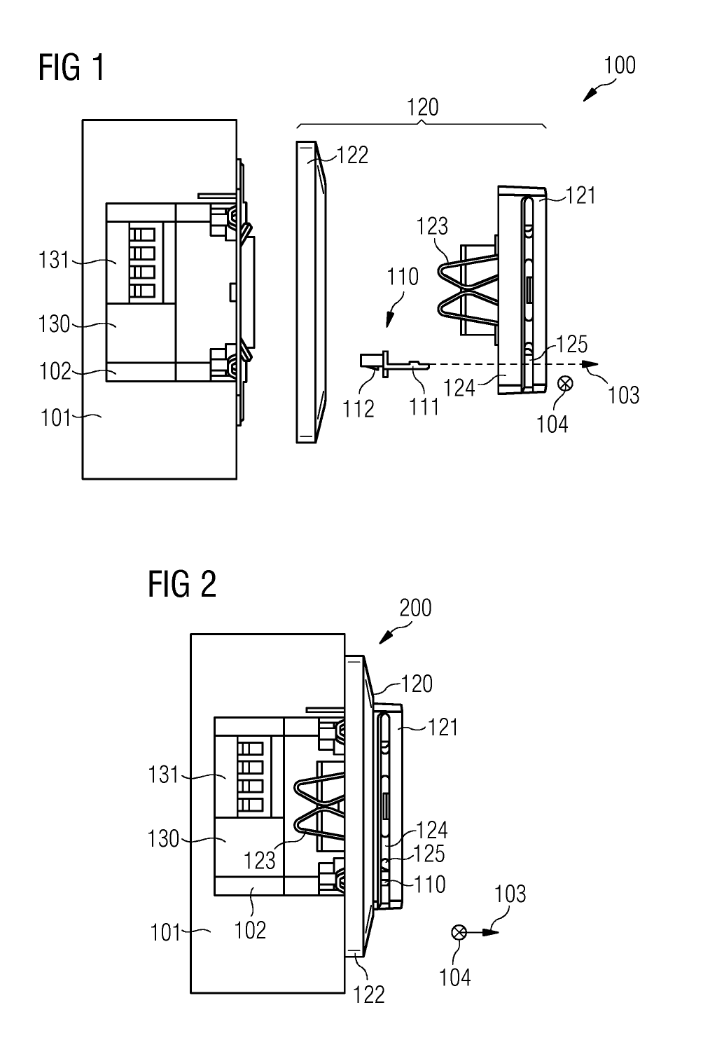

FIG. 1 shows an arrangement 100 with a front module 120 for fitting to a carrier module 130 able to be attached to a wall 101 and a device for anti-theft fixing of the front module 120 to the carrier module 130. The device has an anti-theft facility 110. The anti-theft facility 110 is embodied such that, the front module 120 and the carrier module 130 are able to be fixed to one another by the device. The anti-theft facility 110 is able to be released from the front module 120 and/or the carrier module 130 exclusively by a special tool.

The anti-theft facility 110 has a first end section 111 and a second end section 112. To form a first fixing the anti-theft facility 110 is able to be attached by its first end area 111 to a first attachment area of the front module 120.

In the exemplary embodiment in FIG. 1 the front module 120 of a function device 121 and a frame 122. The function device 121 can for example represent a switch, a thermostat, a display or the like. The frame 122 surrounds the function device 121 and is attached between the wall 101 and the function device 121. The first attachment area can be embodied in other typical embodiments to also form the first fixing in the frame 122.

The front module 120 can have attachment elements 123 which in the exemplary embodiment in FIG. 1 are arranged on the function device 121. The attachment element 123 can for example have spreading clips, as shown in FIG. 1. As an alternative screw connections or other attachment elements 123 can also be used. The spreading clips 123 can typically clip onto the carrier module 130 so that an attachment between the function device 121 and thus between the front module 120 and the carrier module 130 is able to be provided.

The carrier module 130 is typically arranged in a cavity 102 of the wall 101. For example the carrier module 130 can have a mounting plate with which the carrier module 130 is able to be attached to the wall 101. The carrier module 130 also has a connecting element 131. The connecting element 131 can for example be connected to a line which runs within the wall for signal transmission. On the other hand the connecting element can likewise have a transmit and/or receive module in order to transmit signals which are received from the function device 121 to a remote base station wirelessly. The transmit and/or receive module can also be arranged in the function device 121. The connection element 131 is also embodied to be connected to a corresponding connection facility of the function device 121 for signal transmission.

As shown in FIG. 1, the front module 120 or the function device 121 has a narrow side 124. The narrow side 124 is the side surface of the function device 121, wherein the narrow side 124 has a plane with a normal which runs in parallel to the wall surface 101 or which is aligned at right angles to a normal of a wall plane in which the wall surface of the wall 101 runs.

Embodied in the narrow side 124 is an access opening 125. A special tool can be introduced through the access opening 125 in order to release the first fixing between the first end area 111 of the anti-theft facility 110 and the first attachment area of the front module 120 or of the function device 121 from each other.

As shown in FIG. 1, the anti-theft facility 110 is able to be inserted in a first direction 103 into the attachment area of the function device 121. The first direction 103 is for example embodied parallel to a normal of the wall plane along which the wall surface of the wall 101 runs.

The access opening 125 is embodied such that a special tool, which is able to be inserted through the access opening 125 to released the first fixing, can be introduced in a second direction 104. The second direction 104 differs from the first direction 103. In the exemplary embodiment in FIG. 1 the first direction 103 runs at right angles to the second direction 104.

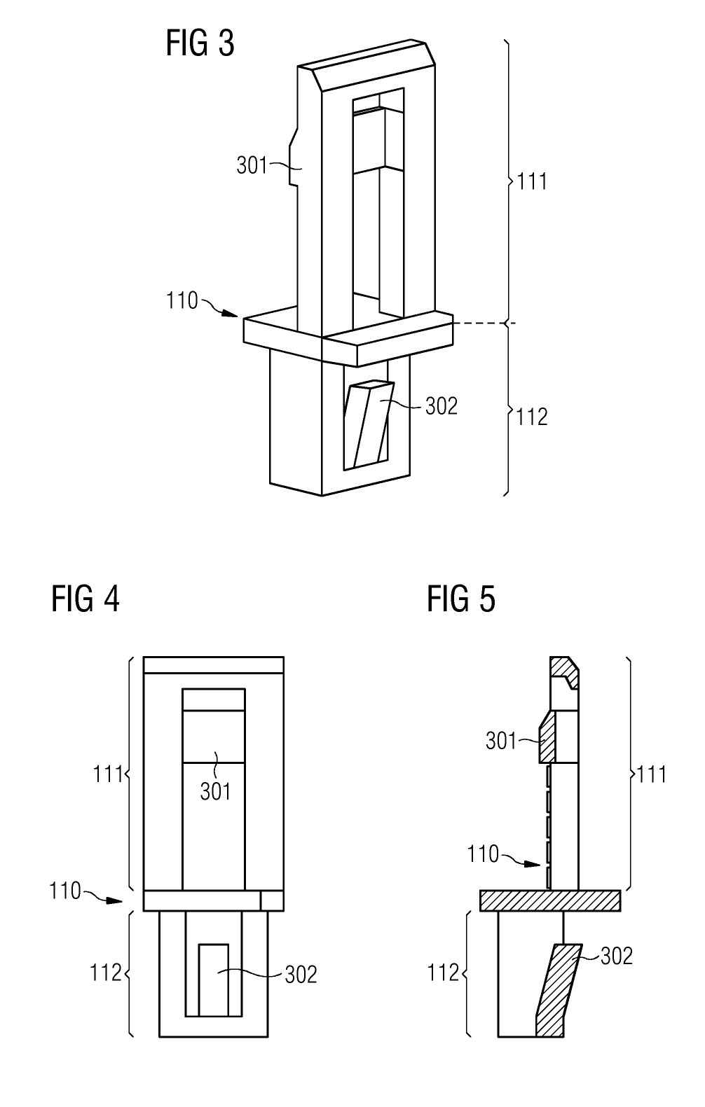

In the exemplary embodiment in FIG. 1 the anti-theft facility 110 has a first snap-on element 301 on its first end section 111 (see FIG. 3) which creates a snap-on or latch-on fixing with the first attachment area of the function device 121. The special tool is inserted for releasing the first fixing into the first access opening 125. The special tool deforms the first end section 121 and thus releases the latch-on connection between the first end section 111 and the function device 121. Only after a release of the first fixing can the function device 121 along with frame 122 be released from the carrier module 130.

The second end area 112 of the anti-theft facility 110 is able to be attached to a second attachment area of the carrier module 130. The second fixing between the second end area 112 and the second attachment area of the carrier module 130 can likewise be implemented via a snap-on or latch-on connection. In addition a screw connection can likewise be implemented between the second end area 112 and the attachment area of the carrier module 130. The second fixing can for example only then be released when the front module 120 is taken off, since the front module 120 encloses or houses the anti-theft facility 110 and the attachment areas.

FIG. 2 shows a typical embodiment in which the front module 120 is fixed to the carrier module 130 which is attached in the wall. The arrangement 100 of the anti-theft facility 110 and the front module 120, with the carrier module 130 forms a system 200. The embodiment in FIG. 2 has the same features as the embodiment in FIG. 1. In FIG. 2 it is more clearly evident that through the access opening 125 in the narrow side 124, an area of the anti-theft facility 110, especially the first end section 111, is able to be reached by the special tool. The special tool can be inserted into the access opening 125 in the second direction 104 which runs into the plane of the drawing in FIG. 2, in order to release the first fixing. Subsequently or at the same time the user must release the front module 120 including the function device 121 and the frame 122 from the carrier module 130. It is not possible to remove the front module 120 without the special tool. The access opening 125 has such small dimensions (e.g. a diameter of less than 1 cm) that it is impossible to reach the anti-theft facility 110 manually or by hand.

FIG. 3 to FIG. 5 show a more detailed representation of a typical embodiment of the anti-theft facility 110. FIG. 3 here shows a perspective view of the anti-theft facility 110, FIG. 4 shows a front view of the anti-theft facility 110 and FIG. 5 shows a cross-sectional view from the side of the anti-theft facility 110.

The anti-theft facility 110 includes the first end area 111 and the second end area 112. Embodied in the first end area 111 is a first snap-on element 301 to embody a snap-on connection, especially the first fixing. To form a second snap-on connection or the second fixing the second end section 112 has a second snap-on element 302. The second snap-on element 302 can for example be embodied as a snap-on connection with a second attachment area of the carrier module 130.

The first snap-on element 301 and the second snap-on element 302 each form a snap hook or a snap-on wedge. The anti-theft facility 110 can be introduced for example with its first end area 111 into a recess of the first attachment area of the front module 120.

The second area 112 with the second snap-on element 302 can embody a corresponding snap-on connection with the carrier module 130. The second attachment area of the carrier module 130 and the second end section 112 with the associated second snap-on element 302 can be embodied in accordance with the first attachment area of the front module 120 and the first end section 111 with the first snap-on element 301.

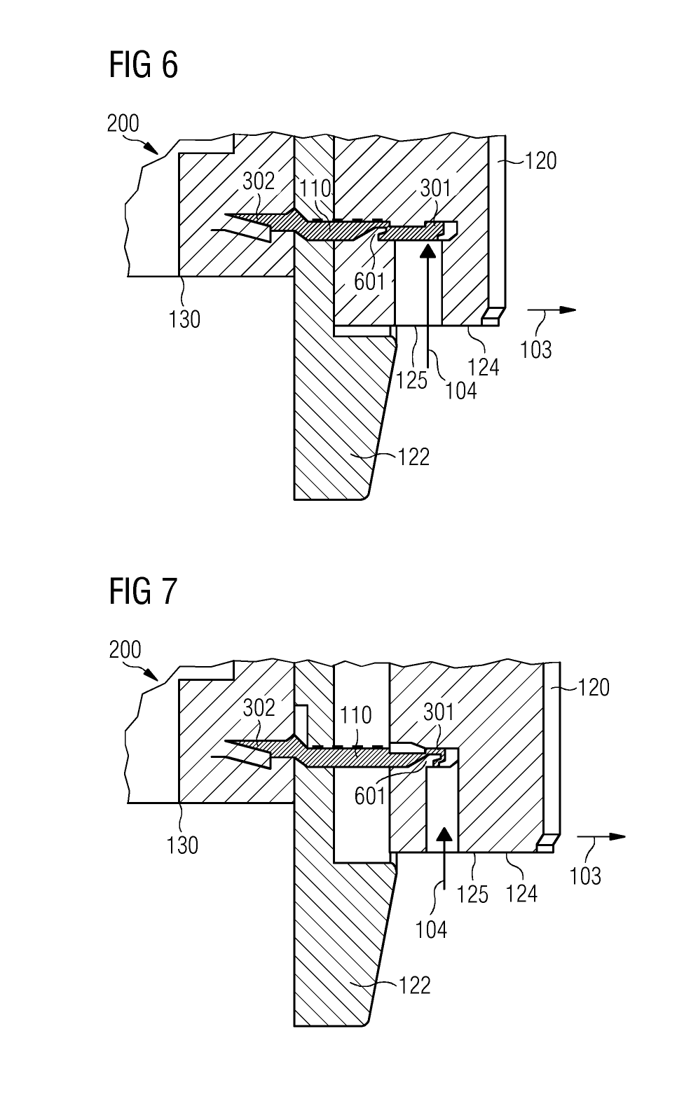

FIG. 6 and FIG. 7 show a system 200, in which the anti-theft facility 110, which has the snap-on element 301, is fixed to the front module 120. The receptacle opening of the first attachment area of the front module 120 can for example embody an (e.g. inner) overhang/mating hook 601. During the insertion of the anti-theft facility 110 in the first direction 103 into the receptacle opening the first end area 111 of the anti-theft facility 110 deforms elastically, since during the insertion the overhang 601 in the receptacle opening deforms the first snap-on element 301 and thus the first end section 111 (e.g., elastically). After the first snap-on element 301 has been pushed over the overhang 601 in the receptacle opening, the first end section 111 springs back into its initial position, so that the first snap-on element 301 wedges with the overhang 601 in the receptacle opening. FIG. 6 shows an anti-theft facility 110 which is inserted into the receptacle opening.

FIG. 7 shows a relative position between the front module 120 and the carrier module 130, in which position the snap-on element 301 is wedged with the overhang 601. This position arises when the front module 120 is removed from the carrier module 130 without the snap-on element 301 having been bent away from the overhang 601 by the special tool. A further removal of the front module 120 from the carrier module 130 in the first direction 103 is thus prevented. A special tool is needed to release the first fixing, which deforms the first end section 111 elastically or plastically again so that the wedging between the first snap-on element 301 and the overhang 601 is released. During the release of the first fixing between the first snap-on element 301 and the overhang 601 in the receptacle opening the anti-theft facility 110 or the front module 120 can be released from one another by pulling them in the first direction 103. Theft of the front module 120 by a user who does not have the special tool to hand is therefore not possible.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

In addition it should be pointed out that “comprising” or “including” does not exclude any other elements and “a” or “an” do not exclude a plurality. In addition it should be pointed out that features which have been described with reference to one of the above exemplary embodiments can also be used in combination with other features of other exemplary embodiments described above.

What is claimed is:

1. A device for anti-theft fixing of a front module to a carrier module able to be attached to a wall, said device comprising
an anti-theft facility by which the front module and the carrier module are fixed to one another, the anti-theft facility exclusively being released from the front module and/or the carrier module by a special tool.

2. The device as claimed in claim 1, wherein the front module has a first attachment area and the carrier module has a second attachment area, and
wherein the anti-theft facility comprises:
a first end section shaped such that a first fixing is able to be established to the first attachment area of the front module, and
a second end section shaped such that a second fixing is able to be established to the second attachment area of the carrier module, and at least one of the first end section and the second end section release the first fixing or the second fixing, respectively, exclusively by use of the special tool.

3. The device as claimed in claim 2, wherein the first end section has a first snap-on element that snaps onto the first attachment area of the front module.

4. The device as claimed in claim 3, wherein the second end section has a second snap-on element that is inserted into the second attachment area of the carrier module.

5. The device as claimed in claim 3, wherein the second end section is screwed into the second attachment area of the carrier module.

6. An arrangement attachable to a carrier module attached to a wall, comprising
a front module accommodating the carrier module; and
a device including an anti-theft facility by which the front module and the carrier module are fixed to one another, the anti-theft facility exclusively being released from at least one of the front module and the carrier module by a special tool.

7. The arrangement as claimed in claim 6, wherein the front module has an access opening surrounding the anti-theft facility and providing access by the special tool to release the anti-theft facility, exclusively therethrough.

8. The arrangement as claimed in claim 7, wherein the access opening forms a cross-sectional shape matching a profile shape of the special tool.

9. The arrangement as claimed in claim 7, wherein the front module has a narrow side in which the access opening is formed.

10. The arrangement as claimed in claim 9,
wherein the front module has a receptacle opening accommodating the anti-theft facility, the anti-theft facility being inserted in a first direction into the receptacle opening, and
wherein the access opening is embodied such that the special tool is able to be inserted in a second direction into the access opening, the first direction differing from the second direction.

11. A system for attaching to a wall, comprising
a carrier module attachable to the wall, and
an arrangement including
a front module accommodating the carrier module; and
a device including an anti-theft facility by which the front module and the carrier module are fixed to one another, the anti-theft facility exclusively being released from at least one of the front module and the carrier module by a special tool.

12. The system as claimed in claim 11, wherein the carrier module is embodied to cover a cavity in the wall.

13. The system as claimed in claim 12,
wherein the front module includes a function device,
wherein the carrier module includes a connecting element, and
wherein the function device connectable to the connecting element for signal transmission.

14. The system as claimed in claim 13, wherein when a line is connected between the wall and the connecting element providing signal transmission, the function device is able to provide a connection from outside the wall to the connecting element.

15. A method for anti-theft fixing of a front module to a carrier module attachable to a wall, said method comprising:
fixing the front module to the carrier module by a device including an anti-theft facility by which the front module and the carrier module are fixed to one another, the anti-theft facility exclusively being released from at least one of the front module and the carrier module by a special tool.
